(19) United States
(12) Patent Application Publication
(10) Pub. No.: US 2011/0002431 A1
(43) Pub. Date: Jan. 6, 2011

(54) METHOD FOR DIRECT PRODUCTION OF 99mTc - TECHNETIUM 99 METASTABLE FROM LOW ENERGY ACCELERATORS

(76) Inventors: Richard Ray Johnson, Vancouver (CA); Luís Francisco de Oliveira Marques Metello, Ermesinde (PT); Lídia Alexandra dos Santos Cunha, Ermesinde (PT); Vesna Sossi, Vancouver (CA)

Correspondence Address: POTOMAC PATENT GROUP PLLC, P. O. BOX 270, FREDERICKSBURG, VA, 22404, US

(21) Appl. No.: 12/512,529

(22) Filed: Jul. 30, 2009

(30) Foreign Application Priority Data
Jul. 1, 2009 (PT) 104656

(51) Int. Cl. H05H 6/00; G21G 1/10

(52) U.S. Cl. 376/151; 376/194; 376/202; 376/195

(57) ABSTRACT

Target, computer software and method for direct production of ^{99m}Tc using small energy accelerators. The method includes positioning a target holder to be bombarded with a beam of protons, the target holder having a target that includes a first hard core layer, a second hard core layer, a third layer of highly enriched ¹⁰⁰Mo and a substrate, distributed in this order; bombarding the target with the beam of protons, wherein the protons have an energy between 10 and 35 MeV and a current between 20 and 500 μA; and terminating the bombarding with the beam of protons after a time interval between half an hour and 8 hours.

### BACKGROUND

1. Technical Field

Embodiments of the subject matter disclosed herein generally relate to methods for producing Technetium-99 metastable (^{99m}Tc) directly from low energy, so called “medical”, accelerators.

2. Discussion of the Background

At present ^{99m}Tc provides up to 90% of the isotopic products used in Nuclear Medicine, i.e., various imaging mechanisms that includes SPECT (Single Photon Emission Computer Tomography), gSPECT (gated SPECT), Planar Imaging, etc. A crisis in the supply of ^{99m}Tc radioisotope in the last two decade is affecting the Nuclear Medicine Departments all over the world, with the potential of prejudicing an increased number of patients and clinicians that relies on this powerful complementary diagnostic imaging technology.

The standard way of producing ^{99m}Tc is through Generator Units loaded with the parent radioisotope, Molybdenum-99 (⁹⁹Mo), that has a half-life time of 66 h. The supply of ⁹⁹Mo relies on access to nuclear research reactors and nuclear fission radiochemical processing. However, the ²³⁵U—Uranium-235 fission induced ⁹⁹Mo production creates large quantities of long half-life radioactive waste as well as fissionable material. It is known that approximately 97% of the Highly Enriched Uranium (Weapons Grade Uranium) originally present in the reactor targets ends up in the process waste.

Consequently, the accumulating waste from ⁹⁹Mo production contains worldwide tens of kilograms of Highly Enriched Uranium (HEU). The HEU could be, eventually, recovered for reuse, but currently no producer has active plans to do so, presumably because it is less costly to purchase fresh HEU. Accessing highly enriched target material for ⁹⁹Mo production is becoming more difficult, and the disposal of radioactive waste remains a major concern.

Another problem facing the production of ⁹⁹Mo is that most of the reactors used for the production of ⁹⁹Mo are approaching the end of their exploitation. The Petten (Holland) and NRU-AECL (Canada) facilities, built in 1950's and 1960's respectively, are subject to service interruptions and long repair times, with weeks—and even month—long interruptions, making that Nuclear Medicine procedures suffers profound consequences, as, without having access to the necessary daily activities, it is impossible to perform these procedures, creating critical problems for the patients and clinicians involved.

There is a continuing concern about the future supply of fission ⁹⁹Mo. Several alternative methods of producing ⁹⁹Mo have already been proposed as disclosed by D. M. Devi, in Eur J Nucl Med Mol Imaging DOI 10.1007/s 00259-009 1171-4, (herein “Devi”) the entire content of which is enclosed herein by reference. Such procedures involve returning to the traditional “non-fission” reactor irradiations, upgrades of cyclotrons to produce high-beam currents to directly produce ^{99m}Tc, large accelerators for spallation reactions and electron accelerators, exploitation of liquid-core reactors, etc. All these alternative methods pose severe technical risks and imply major infrastructure changes for ⁹⁹Mo production and ^{99m}Tc generator delivery.

New efforts to produce ⁹⁹Mo using an intense electron current, accelerator created, photon-induced nuclear fission have been reported. However, these methods are not mature enough to produce a constant supply of metastable ⁹⁹Tc. Several authors have reported a variety of data from proton-induced reaction cross-sections on molybdenum in the medium-energy range, but they present large discrepancies. The reported inconsistencies severely limit the reliability of data evaluations. References: B. Schotten, R. M. Lambrecht, M. Cogneau, H. Vera Ruiz, S. M. Qaim Applied Radiation and Isotopes 51 (1999) 69-80.

One alternative approach to directly produce ^{99m}Tc is to use small proton accelerators (also called medical cyclotrons). Over three hundred units of medical cyclotrons all around the world are now sited in major hospitals and regional (centralized) radiopharmacies to supply ¹⁸F-FDG (radioactive isotope fluorine-18 in 2-fluoro-2-deoxy-D-glucose) to Nuclear Medicine Departments.

The direct production of ^{99m}Tc has been described by Devi as an “untried method that would have low capacity and would require large amounts of enriched ¹⁰⁰Mo as the raw material.” Thus, there is skepticism among the skilled in the art that this method might work.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of an experimental line used for the direct production process of ^{99m}Tc according to an exemplary embodiment;

FIG. 2 is a schematic of a three layer Target according to an exemplary embodiment;

FIG. 3 is a flow chart illustrating the steps for obtaining the ^{99m}Tc according to an exemplary embodiment;

FIG. 4 is a schematic diagram of a general controller that controls the process of obtaining ^{99m}Tc;

FIG. 5 is a sketch illustrating the separation mechanism of ^{99m}Tc from the ¹⁰⁰Mo Target material and the recovery of each; and

FIG. 6 is a flow chart illustrating steps for obtaining the ^{99m}Tc according to another exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of small cyclotron. However, the embodiments to be discussed next are not limited to a small cyclotron, but may be applied to other structures that emit protons or other particles.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

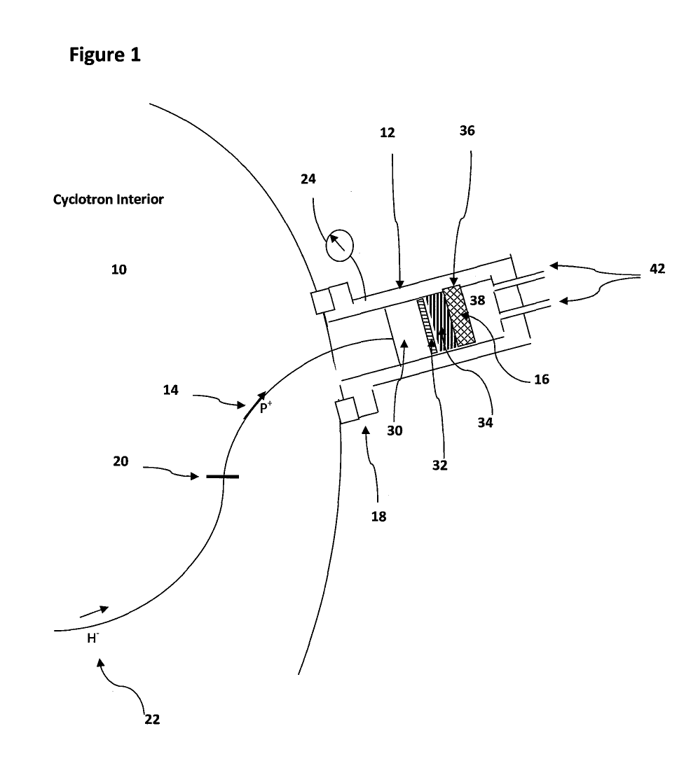

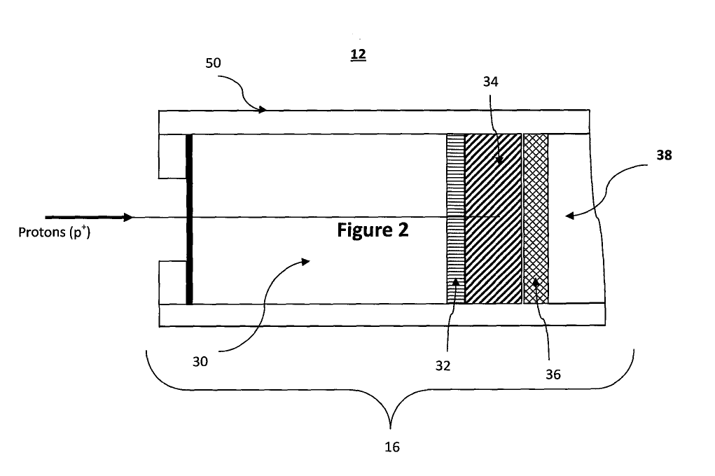

Small energy cyclotrons may be used for the direct production process of ^{99m}Tc to allow the enlargement of the field of possible users. According to an exemplary embodiment illustrated in FIGS. 1 and 2, protons are accelerated in a cyclotron 10, which results in a proton beam 14. The proton beam 14 may be directed as necessary to a Target 16. Those skilled in the art would appreciate that magnets or electromagnets may be used to direct the beam to an appropriate location.

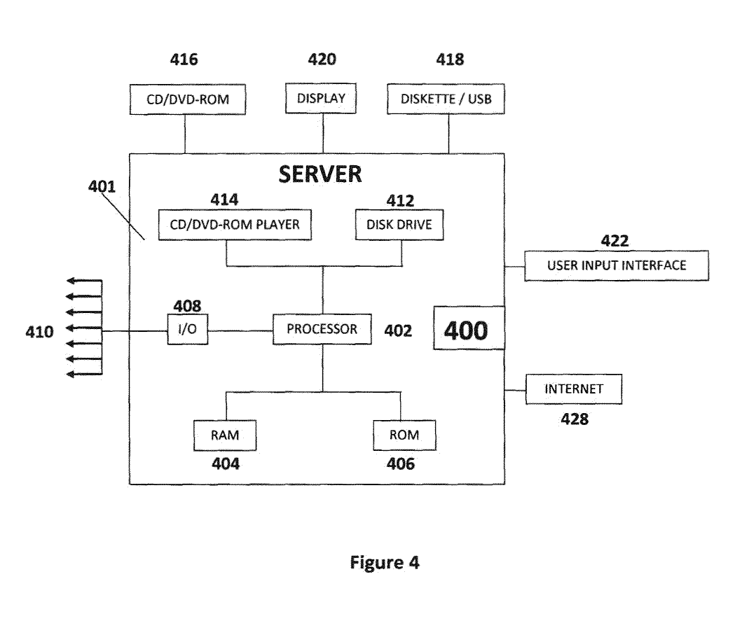

According to an exemplary embodiment, the beam 14 has a controllable energy, which is determined by how long the protons have been accelerated before they exit the Cyclotron and get into the Target region, a controllable current, which is determined by the number and velocity of protons in the beam, and a controllable direction, which is determined by the deflecting devices (not shown in the pictures). All these features may be controlled by a general controller. The general controller may include dedicated circuitry and/or microprocessors controlled by software. The general controller (which is described in more details with regard to FIG. 4) may be connected to various sensors, disposed in the vacuum chamber and/or on the Target 16 for collecting various data, for example, temperature and pressure. The electrical data transmitters may be wired or wireless or communicate via other means known by those skilled in the art.

The sensors may also include other elements, as for example, a switch activating a robotic system for rotating and/or translating the Target, activating a cooling system (to be discussed later) or performing other functions inside the vacuum chamber.

The proton beam 14 impinges on Target 16 of highly enriched (>97%) ¹⁰⁰Mo. The time of bombardment of the Target with the proton beam may also be controlled by the general controller. When the highly enriched ¹⁰⁰Mo reacts with the protons, the nuclear reaction ¹⁰⁰Mo (p,2n) ^{99m}Tc takes place.

One of ordinary skill in the art would recognize that there is a very larger number of combinations of reaction parameters, (i.e., proton energy, proton current, time of bombardment and/or Target composition) for the above noted reaction and the Background of the Invention section have discussed attempts of others to use this reaction to efficiently produce ^{99m}Tc. However, as discussed next, certain novel combinations of these reaction parameters determine a high yield of ^{99m}Tc after bombardment.

A Target Holder 12, including the Target 16, may be attached to the Cyclotron 10 with an attaching mechanism 18. The attaching mechanism 18 may include, for example, a flange attached to the Target Holder 12 and plural screws that are tightening the Target Holder 12 to the Cyclotron 10. Other mechanisms for attaching the Target Holder 12 to the Cyclotron 10 may be used. The Target Holder 12 may have different sizes and shapes as dictated by the corresponding Cyclotron in order to mate with ports of the Cyclotron. However, according to an exemplary embodiment, a structure (order of layers) of the Target 16, which is described later, remains the same irrespective of the cyclotron. Not shown in the figures is a mechanism for attaching Target 16 to the Target Holder 12. However, one skilled in the art would not that, for example, the Target 16 may be attached with a spring system to the Target Holder 12, or other appropriate means. Target 16 may be introduced into Target Holder 12 either through a opening made on a side of the Target Holder 12, which is then covered by a door. Alternatively, Target 16 may be introduced in the Target Holder 12 before the Target Holder 12 is attached to the Cyclotron 10 and/or through an opening at the opposite end of the Target Holder 12, i.e., where pipes 42 are shown in FIG. 1. That end of the Target Holder 16 may have a cap that may be removed manually or by a remote controlled device. This feature has the advantage that the removal of the Target Holder 12 and/or the cap by the remote controlled device ensures the safety of the operator especially when the radioactive Tc has been formed and needs to be removed.

A carbon foil 20 may be placed in the way of a beam of accelerated ions of H⁻ 22. The interaction between the carbon foil 20 and the ions 22 results in the removal of two electrons from the ions 22, which generate the beam of protons 14. The resulting beam of protons 14 is extracted by known means from the Cyclotron 10 and directed to Target 16. One or more sensors 24 may be placed next to the Target 16. FIG. 1 shows a beam current sensor, which is configured to measure a current of the protons beam 14. FIG. 1 also shows that Target 16 includes plural layers 30, 32, 34, and 36 and at least one chamber 38. These layers and chambers are discussed later.

In one embodiment, the bombardment of the Target will be performed using accelerated protons having energy between 10 and 14 MeV. In another embodiment, the bombardment of the Target will be performed using accelerated protons having energy between 14 and 16 MeV. In another embodiment, the proton energy is between 16 and 19 MeV. In still another embodiment, the energy of the protons is between 19 and 24 MeV. In still another embodiment, the energy of the protons is between 24 and 30 MeV. In yet another embodiment, the energy of the protons is between 30 and 35 MeV.

In terms of the current of protons, according with one embodiment, the bombardment of the Target is performed with the beam of protons having a current between 20 μA and 50 μA. In another embodiment the bombardment of the Target is performed with the beam of protons having a current between 50 μA and 75 μA. In another embodiment the bombardment of the Target is performed with the beam of protons having a current between 75 μA and 100 μA. In another embodiment the bombardment of the Target is performed with the beam of protons having a current between 100 μA and 125 μA. In another embodiment the bombardment of the Target is performed with the beam of protons having a current between 125 μA and 150 μA. In another embodiment the bombardment of the Target is performed with the beam of protons having a current between 150 μA and 175 μA. In another embodiment the bombardment of the Target is performed with the beam of protons having a current between 175 μA and 200 μA. In another embodiment the bombardment of the Target is performed with the beam of protons having a current between 200 μA and 225 μA. In another embodiment the bombardment of the Target is performed with the beam of protons having a current between 225 μA and 250 μA. In another embodiment the bombardment of the Target is performed with the beam of protons having a current between 250 μA and 275 μA. In another embodiment the bombardment of the Target is performed with the beam of protons having a current between 275 μA and 300 μA. In another embodiment the bombardment of the Target is performed with the beam of protons having a current between 300 μA and 325 μA. In another embodiment the bombardment of the Target is performed with the beam of protons having a current between 325 μA and 350 μA. In another embodiment the bombardment of the Target is performed with the beam of protons having a current between 350 μA and 375 μA. In another embodiment the bombardment of the Target is performed with the beam of protons having a current between 375 μA and 400 μA. In another embodiment the bombardment of the Target is performed with the beam of protons having a current between 400 μA and 425 μA. In another embodiment the bombardment of the Target is performed with the beam of protons having a current between 425 μA and 450 μA. In another embodiment the bombardment of the Target is performed with the beam of protons having a current between 450 μA and 475 μA. In another embodiment the bombardment of the Target is performed with the beam of protons having a current between 475 μA and 500 μA.

In terms of the time of bombardment, various time intervals are considered. In one embodiment the time of bombardment of the Target with the proton beam is between 30 minutes and 120 minutes. In another embodiment the time of bombardment of the Target with the proton beam is between 2 and 3 hours. In another embodiment the time of bombardment of the Target with the proton beam is between 3 and 4 hours. In another embodiment the time of bombardment of the Target with the proton beam is between 4 and 5 hours. In another embodiment the time of bombardment of the Target with the proton beam is between 5 and 6 hours. In another embodiment the time of bombardment of the Target with the proton beam is between 6 and 7 hours. In another embodiment the time of bombardment of the Target with the proton beam is between 7 and 8 hours.

Combinations of the energy of protons, the current of protons, and the time of bombardment from the intervals noted above may be used for obtaining the ^{99m}Tc. For example, a 200 μA two hours bombardment of a production Target of conveniently enriched ¹⁰⁰Mo will produce an estimated ^{99m}Tc yield of 1.4 Ci (51.8 GBq).

According to another embodiment, the Target 16 may have a structure as shown in FIGS. 1 and 2. Namely, at higher level of detail and magnification, FIG. 2 shows that Target Holder 12 includes a case 50, in which Target 16 is provided. Target 16 may include, according to an exemplary embodiment, layers 30, 32, 34, and 36 in this order. Layers 30, 32 and 34 form a target compound and layer 36 is the substrate of the target. Layer 30 is a first hard core layer that isolates the target layer 34 from the cyclotron. Layer 30 may include a metal that can withstand the temperature and pressure conditions, such as, for example, Aluminum or Havar™. The second hard core layer 32 separates the target layer 34 from layer 30. The third layer 34, i.e., the target layer, includes the highly enriched ¹⁰⁰Mo, in a metal or oxide chemical form. These three layers 30, 32, and 34 are distributed in this order on the substrate layer 36. It is noted that the drawing is not to scale, i.e., layers 30, 32, and 34 may have different sizes and shapes than those shown in FIG. 2. These layers 30, 32, and 34 may be placed upon a fourth layer (layer number 36) that it is the Target Substrate, which provides the mechanical support for the Target material itself (layer number 34). Optionally, a cooling system 38 may be provided on the back of the Target (and/or eventually side) regions to control the temperature of the Target 16 during and/or after proton bombardment. The cooling system 38 may be a chamber formed next to one or more of layers 32, 34, and 36 that has inlet and outlet 42 (see FIG. 1) for providing the coolant liquid. The inlet and outlet 42 may be configured to be detachably attach to a corresponding coolant supply source (not shown) such that after the irradiation with the proton beam 14, the Target 16 may be manually or automatically detached from the cyclotron 10 and delivered to a processing location (not shown). According to another exemplary embodiment, the inlet and outlet 42 and/38 cooling system 38 may be part of the Target Holder 12 and the Target 16 may be removed from the Target Holder 12 without removing the inlet and outlet 42 and/or cooling system 38.

In an exemplary embodiment, a thickness of the first hard core layer 30 is between 25 μm and 500 μm, a thickness of the second hard core layer 32 is between 25 μm and 500 μm, a thickness of the third highly enriched ¹⁰⁰Mo layer 34 is between 40 μm and 1500 μm. The first hard core layer 30 may be shaped in a form specific for each type and model of Target holder existing on the market, so providing specific solutions for any type and model already existing (or to become present).

In an embodiment, the first hard core layer 30 may include one of Niobium (Nb), Platinum (Pt), Tantalum (Ta) and Silver (Ag). In an embodiment, the second hard core layer 32 may include one of Aluminum (Al), either in metal, salt or oxide chemical form, and Copper (Cu) either in metal, salt or oxide chemical form.

In an embodiment the third layer 34 of highly enriched ¹⁰⁰Mo in metal or oxide chemical form, may have a purity of at least 95%. In another embodiment, the third layer of highly enriched ¹⁰⁰Mo in metal or oxide chemical form may have a purity of at least 97%. In still another embodiment, the third layer of highly enriched ¹⁰⁰Mo in metal or oxide chemical form may have a purity of at least 98%. In yet another embodiment, the third layer of highly enriched ¹⁰⁰Mo in metal or oxide chemical form, may have a purity of at least 99%. In still another embodiment, the third layer of highly enriched ¹⁰⁰Mo in metal or oxide chemical form may have a purity of at least 99.5%. In another embodiment, the third layer of highly enriched ¹⁰⁰Mo in metal or oxide chemical form may have a purity of at least 99.7%.

The Target 16 may be cooled with the cooling system 38 by using, for example, a cooling agent that is flown through an enclosed cavity of the cooling system 38. In one embodiment, the cooling agent is Deionised Water. In another embodiment the cooling agent is Nitrogen (N₂). In still another embodiment the cooling agent is Helium (He). The flow of the cooling agent may be controlled by the general controller.

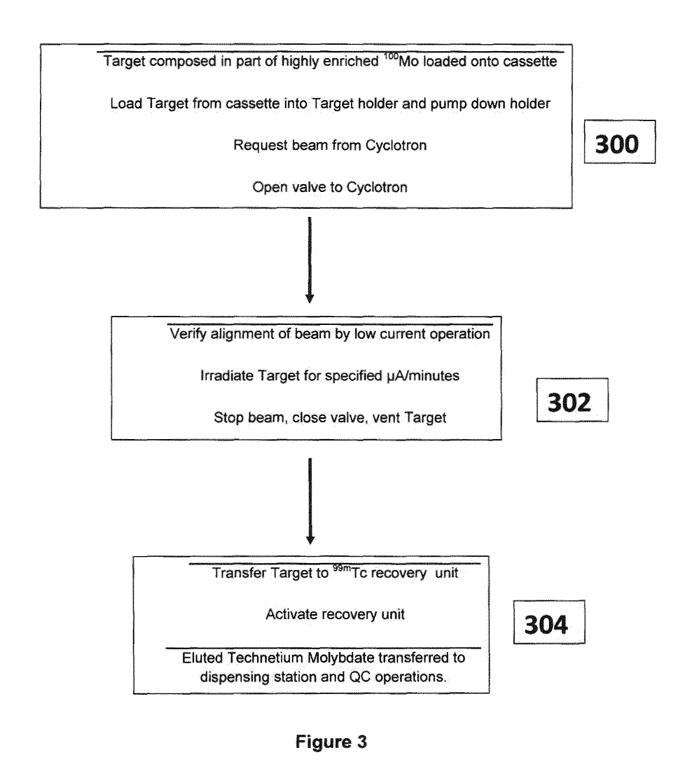

According to an exemplary embodiment illustrated in FIG. 3, steps of a method for obtaining ^{99m}Tc are discussed next. The method for producing ^{99m}Tc includes a step 300 of disposing a Target in a Target chamber, the Target including a first hard core layer, a second hard core layer and a third layer of highly enriched ¹⁰⁰Mo distributed in this order. The Target may be loaded onto a cassette and then into a Target Holder. A step 302 includes verifying an alignment of the beam by low current operation, after an valve of the cyclotron is opened to allow the beam to reach the Target. When the desired alignment is achieved, the Target is bombarded with a beam of protons, wherein the protons have an energy between 10 and 35 MeV and a current between 20 and 500 μA. After a desired time, the beam is stopped, the valve is closed and the Target is vented. The bombardment with the beam of protons may last for a time interval between half an hour and 8 hours. In step 304 the Target is transferred to a Recovery unit and the Recovery unit is activated. The so eluted technetium molybdate is then transferred to a dispensing station and to Quality Control operations.

Some of the features of the above exemplary embodiment are discussed next. The generation of the ^{99m}Tc at local and regional medical cyclotron centers would eliminate the supply chain originating at nuclear reactor or intense electron current accelerator facilities. The method may be used for about 75% of the ^{99m}Tc applications, and may be used by Nuclear Medicine Departments that are based outside the network radius of ¹⁸F-FDG (the tracer fluorine-18 fluorodeoxyglucose, which is widely used in clinical oncology for Positron Emission Tomography scanning) distribution, since the extra time available for distribution, due to different characteristic half-life of ^{99m}Tc (6 hours), allow the distribution for a superior radius than the usual 200 kms of ¹⁸F-FDG.

The ^{99m}Tc may be created and presented to the Nuclear Medicine Radiopharmacist in a manner that blends into their established protocols, following existing procedures for the ¹⁸F-FDG distribution. Thus, no major change is necessary to be performed by the recipients of the ^{99m}Tc.

The Medical Cyclotron approach does not create the fission-induced ⁹⁹Mo production level of waste, since all the waste produced is non-radioactive.

The high purity of the final product obtained in the medical cyclotron production of ^{99m}Tc will allow specific applications where the molecular imaging Targets are limited.

Depending on the proton current and energy, between 74 GBq (2Ci) and 296 GBq (8Ci) per hour of bombardment of ^{99m}Tc may be produced.

The commercial destinations for the ^{99m}Tc are hospitals and/or centralized nuclear pharmacies and companies with units for production and distribution of radiopharmaceuticals, all entities that have small energy medical cyclotrons as part of their existing infrastructure, with priority given to the ones that also have a distribution network.

The ^{99m}Tc would, most likely, replace a large number of the ⁹⁹Mo/^{99m}Tc generators presently in use, therefore decreasing the dependency on the nuclear reactors approaching the end of their exploitation.

The process of generating the ^{99m}Tc may be automatized such that the general controller shown in FIG. 1 controls the time of bombardment, the energy of the protons and the current of the protons based on a composition of the Target that may be provided to the general controller as input.

An example of a representative general controller, or Programmed Logic Controller (PLC), capable of carrying out operations in accordance with the servers of the exemplary embodiments is illustrated in FIG. 4. Hardware, firmware, software or a combination thereof may be used to perform the various steps and operations described herein. The computing structure 400 of FIG. 4 is an exemplary computing structure that may be used in connection with such a controller.

The exemplary computing arrangement 400 suitable for performing the activities described in the exemplary embodiments may include server 401. Such a server 401 may include a central processor (CPU) 402 coupled to a random access memory (RAM) 404 and to a read-only memory (ROM) 406. The ROM 406 may also be other types of storage media to store programs, such as programmable ROM (PROM), erasable PROM (EPROM), etc. The processor 402 may communicate with other internal and external components through input/output (I/O) circuitry 408 and bussing 410, to provide control signals and the like. The processor 402 carries out a variety of functions as is known in the art, as dictated by software and/or firmware instructions.

The server 401 may also include one or more data storage devices, including hard and USB disk drives 412, CD-ROM drives 414, and other hardware capable of reading and/or storing information such as DVD, etc. In one embodiment, software for carrying out the above discussed steps may be stored and distributed on a CD-ROM 416, diskette/USB 418 or other form of media capable of portably storing information. These storage media may be inserted into, and read by, devices such as the CD-ROM drive 414, the disk drive 412, etc. The server 401 may be coupled to a display 420, which may be any type of known display or presentation screen, such as LCD displays, plasma display, cathode ray tubes (CRT), etc. A user input interface 422 is provided, including one or more user interface mechanisms such as a mouse, keyboard, microphone, touch pad, touch screen, voice-recognition system, etc.

The server 401 may be coupled to other computing devices, such as the landline and/or wireless terminals and associated watcher applications, via a network. The server may be part of a larger network configuration as in a global area network (GAN) such as the Internet 428, which allows ultimate connection to the various landline and/or mobile client/watcher devices.

The disclosed exemplary embodiments provide a Target, a method and a computer program product for generating ^{99m}Tc. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a specifically programmed computer or processor.

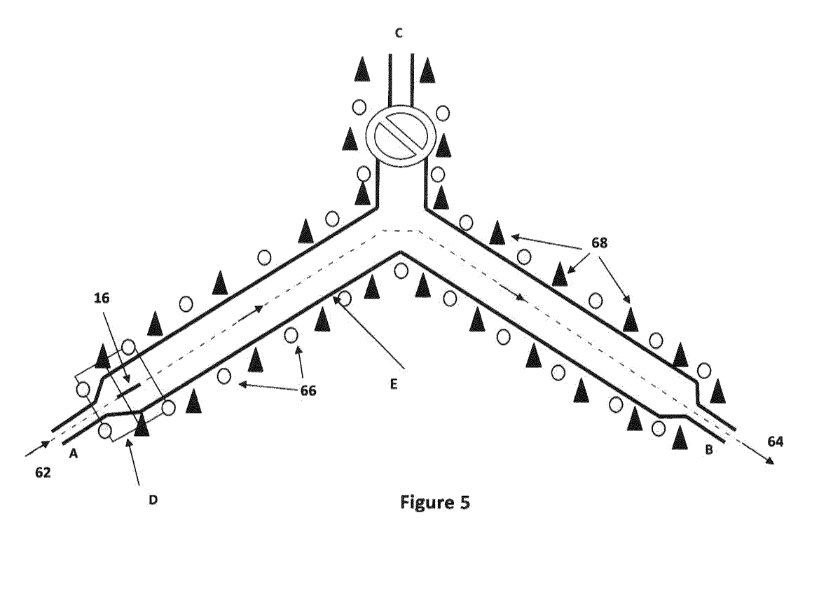

The ^{99m}Tc obtained based on the above discussed exemplary embodiments may still require separation from the Target material of layer 34. In this respect, it is noted that the original layer 34 may include, after bombardment with protons, the original material, i.e., ¹⁰⁰Mb, newly formed ^{99m}Tc, and other by products. This process is presented in schematic form, according to an exemplary embodiment, in FIG. 5. The irradiated Target 16, is placed in a Target column furnace “D” and Oxygen gas 62 is injected at port A. Any gas 64 formed inside column E may be removed at port B. It is noted that furnace D and column E may be either a single unit or two different units that are connected together. Similarly, a temperature of the furnace D and column E may be controlled together or independently one from the other.

A temperature gradient, which may be created by using heating elements 66 distributed along the furnace D and/or column E is established that allows the Target material to oxidize, sublimate and ultimately deposit along the tube according to the condensation temperatures of the Molybdenum and Technetium compounds with the Molybdenum compounds on the left portion and the Technetium compounds on the right side. The elements 66 may be distributed, according to an exemplary embodiment, uniformly (homogeneously) along furnace D and/or column E. A temperature of the furnace D and/or column E is monitored by temperature sensors 68. According to an exemplary embodiment, the temperature sensors 68 are distributed every cm. Furnace D and column E may be cooled by a cooling system (not shown) as would be appreciated by those skilled in the art. A size of each arm of the column E may be between 20 and 100 cm and an internal diameter of these arms may be between 1 and 18 cm. An acid or base may be injected into the column E from port C. The ^{99m}Technetium compounds are eluted from exit B and the ¹⁰⁰Molybdenum compounds are eluted from port A. An apparatus used for manual separation of ⁹⁴MoO₃ and ⁹⁴Tc Compounds (L. Tang, QJ Nucl Med Mol Imaging (2008) 52, 121, the entire content of which is included herein by reference) may appear at a superficial inspection to be similar to the setup shown in FIG. 5. However, Tang's device does not have the possibility to elute the various products independently, which may be advantageous for an efficient production of ^{99m}Tc.

The controlled heat distribution along the column E and/or furnace D allows the irradiated metal target material to oxidize and then sublime. The deposition of the sublimed oxides of Molybdenum and Technetium along the column is controlled by the heat distribution. It is preferable that the elution valve is also heated such as to not capture ^{99m}Tc oxides in that region. A controlled temperature along the column E and furnace D controls the location of sublimation. Pure oxygen is used as the oxidant as well as the transport mechanism. A similar technique has been demonstrated for the separation of ^{95m}Tc from ⁹³Nb (Sekine et al, Jour. Radioanal. and Nucl Chem 239, 5, (1999) 483), the entire content of which is incorporated by reference herewith. The volatility difference of these two materials is greater than for Tc and Mo oxides and this requires a precise temperature distribution along the column. Once the Oxides of Molybdenum and Technetium are separated an elution rinses the Molybdenum and Technetium through different ports. The ^{99m}Tc pertechnate may be sent through a column that would further remove the Molybdenum residue if needed. QC and sterilization proceeds after those steps as well. The recovery of the ¹⁰⁰Mo is likewise accomplished. The ¹⁰⁰Mo elute may be returned to laboratories for reduction into metal (MoO₃+3H₂->Mo+3H₂O) whereby the user may be charged for the amount of ¹⁰⁰Mo that is lost in the process. This typically is less than 5%.

One or more advantages of the exemplary embodiment shown in FIG. 5 includes a controlled heat distribution along the column, especially at region C, a flow of pure oxygen along the column, including region C, and/or a bent at region C that allows the depositions of the left side (region A) and the right side (region B) to be eluted independently from each other. The bent at region C may have an angle between 70 and 175 degrees.

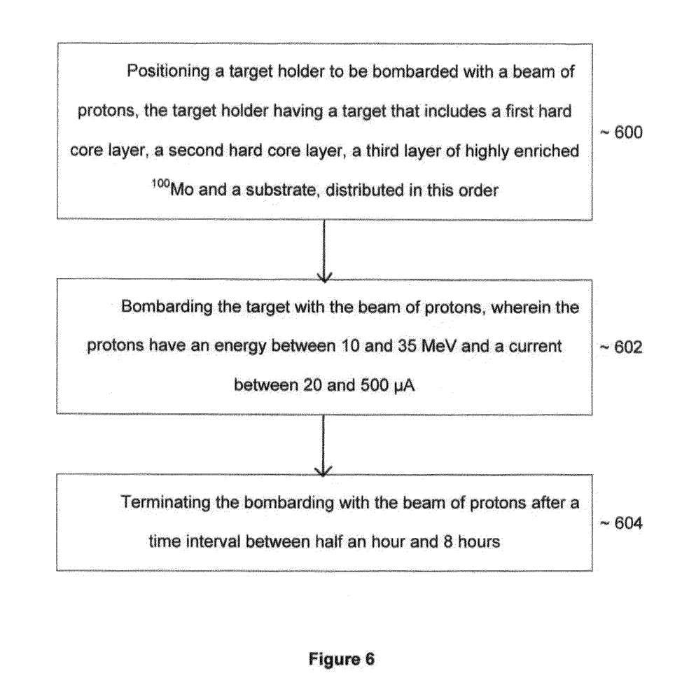

According to an exemplary embodiment, a method for obtaining ^{99m}Tc is discussed with regard to FIG. 6. The method includes a step 600 of positioning a target holder to be bombarded with a beam of protons, the target holder having a target that includes a first hard core layer, a second hard core layer, a third layer of highly enriched ¹⁰⁰Mo and a substrate, distributed in this order; a step 602 of bombarding the target with the beam of protons, wherein the protons have an energy between 10 and 35 MeV and a current between 20 and 500 μA; and a step 604 of terminating the bombarding with the beam of protons after a time interval between half an hour and 8 hours.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other example are intended to be within the scope of the claims if they have structural elements that do not differ from the literal language of the claims, or if they include equivalent structural elements within the literal languages of the claims.

What is claimed is:

1. A method for directly producing ^{99m}Tc from low energy accelerators, comprising:
positioning a target holder to be bombarded with a beam of protons, the target holder having a target that includes a first hard core layer, a second hard core layer, a third layer of highly enriched ¹⁰⁰Mo and a substrate, distributed in this order;
bombarding the target with the beam of protons, wherein the protons have an energy between 10 and 35 MeV and a current between 20 and 500 μA; and
terminating the bombarding with the beam of protons after a time interval between half an hour and 8 hours.

2. The method of claim 1, wherein the first hard core layer may include one of Niobium, Platinum, Tantalum, Silver or Havar.

3. The method of claim 1, wherein the second hard core layer may include one of Aluminum, Silver, and Cupper in metal, salt or oxide chemical form.

4. The method of claim 1, wherein the third layer includes ¹⁰⁰Mo having a purity of at least 95%.

5. The method of claim 4, wherein the purity of ¹⁰⁰Mo is at least 97%, or at least 98%, or at least 99%, or at least 99.5%, or at least 99.7%.

6. The method of claim 1, wherein the energy of the protons is between 10 and 14 MeV, or between 14 and 16 MeV, or between 16 and 19 MeV, or between 19 and 24 MeV, or between 24 and 30 MeV, or between 30 and 35 MeV.

7. The method of claim 1, wherein the current is between 20 and 50 μA, or between 50 and 75 μA, or between 75 and 100 μA, or between 100 and 125 μA, or between 125 and 150 μA, or between 150 and 175 μA, or between 175 and 200 μA, or between 200 and 225 μA, or between 225 and 250 μA, or between 250 and 275 μA, or between 275 and 300 μA, or between 300 and 325 μA, or between 325 and 350 μA, or between 350 and 375 μA, or between 375 and 400 μA, or between 400 and 425 μA, or between 425 and 450 μA, or between 450 and 475 μA, or between 475 and 500 μA.

8. The method of claim 1, wherein the time interval is between half an hour and 3 hours, or between 2 and 3 hours, or between 3 and 4 hours, or between 4 and 5 hours, or between 5 and 6 hours, or between 6 and 7 hours, or between 7 and 8 hours.

9. The method of claim 1, further comprising:
cooling the target with a cooling agent while bombarding the target with the beam of protons.

10. The method of claim 9, where the cooling agent is one of deionised water, nitrogen or helium.

11. A target for producing ^{99m}Tc comprising:
a substrate;
a first hard core layer distributed away from the substrate;
a second hard core layer formed over the substrate; and
a third layer of highly enriched ¹⁰⁰Mo distributed between the second hard core layer and the substrate.

12. The target of claim 11, wherein the first hard core layer includes at least one of Niobium, Platinum, Tantalum, Silver or Havar.

13. The target of claim 11, wherein the second hard core layer may include one of Aluminum, Silver, and Copper in metal, salt of oxide chemical form.

14. The target of claim 11, wherein the third layer includes 100Mo having a purity of at least 95%.

15. The target of claim 14, wherein the purity of ¹⁰⁰Mo is at least 97%, or at least 98%, or at least 99%, or at least 99.5%, or at least 99.7%.

16. The target of claim 1, wherein a thickness of the first layer is between 25 and 500 μm, the thickness of the second layer is between 25 and 500 μm, and the thickness of the third layer is between 40 and 1500 μm.

17. The Target of claim 1, further comprising:
a target holder configured to receive the target.

18. The Target of claim 1, wherein the first hard core layer, the second hard core layer, the third layer and the substrate are formed in this order directly above each other and in direct contact with each other.

19. A computer readable medium including computer executable instructions, wherein the instructions, when executed by a general controller, implement a method for producing ^{99m}Tc, the method comprising:
positioning a target holder to be bombarded with a beam of protons, the target holder having a target that includes a first hard core layer, a second hard core layer, a third layer of highly enriched ¹⁰⁰Mo, and a substrate, distributed in this order;
bombarding the target with a beam of protons, wherein the protons have an energy between 10 and 35 MeV and a current between 20 and 500 μA; and
terminating the bombarding with the beam of protons after a time interval between half an hour and 8 hours.

20. The medium of claim 19, further comprising:
controlling a cooling system of the target, with a cooling agent while and/or after bombarding the target with the beam of protons.

21. The medium of claim 20, where the cooling agent is one of Deionised Water, Nitrogen or Helium.

22. The medium of claim 19, further comprising:
separating Molybdenum and Technetium compounds in a column based on selective distillation.

23. The medium of claim 22, further comprising:
applying an oxygen gas to oxidize the target material and transport it along the column.

24. The medium of claim 19, further comprising:
allowing in a bent column an acid or base to flow along separate sides of the column.

25. A recovery device for separating Molybdenum and Technetium compounds, the device comprising:
a body having first, second and third arms connected together to a connecting region to form a “y” shape, wherein an angle between the first and second arms is between 70 and 175 degrees;
a furnace including a target receiving area configured to receive a pre-irradiated target material, with the target receiving area being connected to the first arm; and
plural coils distributed along of the first arm, the second arm and the third arm and configured to control a temperature within the device, wherein the plural coils are configured to create and maintain under control a desired gradient temperature profile within the recovery device,
wherein the first arm is configured to receive oxygen,
the second arm is configured to release a gas produced by the oxidation of the target material, and
the third arm is configured to receive an acid or a base such that Technetium products formed in the target are eluted from the first arm and Molybdenum products formed in the target are eluted from the second arm.

26. The recovery device of claim 25, further comprising:
plural sensors configured to monitor a temperature of the first arm, second arm, third arm and/or the furnace such that the desired gradient temperature profile is achieved.
